(19) United States
(12) Patent Application Publication
(10) Pub. No.: US 2026/0127080 A1
(43) Pub. Date: May 7, 2026

(54) DATA RECOVERY AFTER DIE FAILURE IN MEMORY DEVICE

(71) Applicant: MICRON TECHNOLOGY, INC., Boise, ID (US)

(72) Inventors: Ke-Cheng Liu, Shanghai (CN); Xue-Sen Yang, Shanghai (CN); Jing-Ping Lu, Shanghai (CN)

(21) Appl. No.: 18/935,992

(22) Filed: Nov. 4, 2024

(51) Int. Cl. G06F 11/14; G06F 11/16

(52) U.S. Cl. CPC G06F 11/1469; G06F 11/1666; G06F 2201/805

(57) ABSTRACT

An example method of performing data recovery after a die failure in a memory device includes: identifying, among a plurality of dies of the memory device, a first die experiencing a failure; identifying, by iterating over an address space associated with the first die, a valid data item stored on the first die; responsive to determining that a data recovery workload condition is satisfied, recovering the valid data item; and storing the valid data item on a second die of the plurality of dies.

### TECHNICAL FIELD

Implementations of the disclosure relate generally to memory sub-systems, and more specifically, relate to performing data recovery after a die failure in memory devices.

### BACKGROUND

A memory sub-system may include one or more memory devices that store data. The memory devices may be, for example, non-volatile memory devices and volatile memory devices. In general, a host system may utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1A illustrates an example computing system that includes a memory sub-system in accordance with aspects of the present disclosure.

FIG. 1B illustrates a block diagram of a memory device in communication with a memory sub-system in accordance with aspects of the present disclosure.

FIG. 2 schematically illustrates an example layout of a memory device, in accordance with aspects of the present disclosure.

FIG. 3A is a high-level flow diagram of an example method of identifying valid data blocks by iterating over physical address space of a chosen die, by a memory sub-system controller operating in accordance with aspects of the present disclosure.

FIG. 3B is a high-level flow diagram of an example method of identifying valid data blocks by iterating over logical address space of the memory device, by a memory sub-system controller operating in accordance with aspects of the present disclosure.

FIG. 4 is a high-level flow diagram of an example method 400 of decoding encoded codewords by a memory sub-system controller operating in accordance with aspects of the present disclosure.

FIG. 5 is a block diagram of an example computer system in which implementations of the present disclosure may operate.

### DETAILED DESCRIPTION

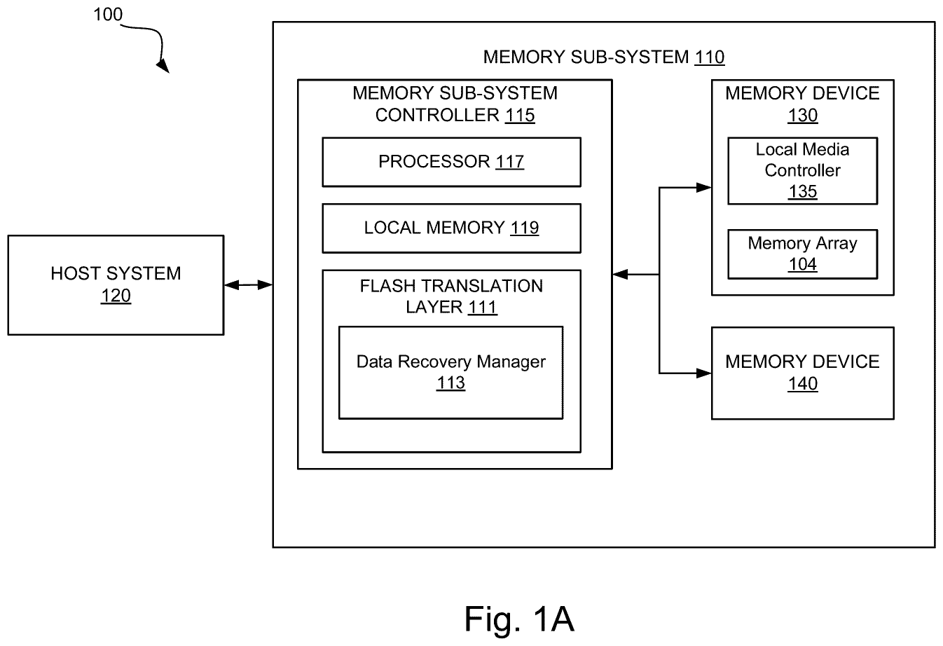

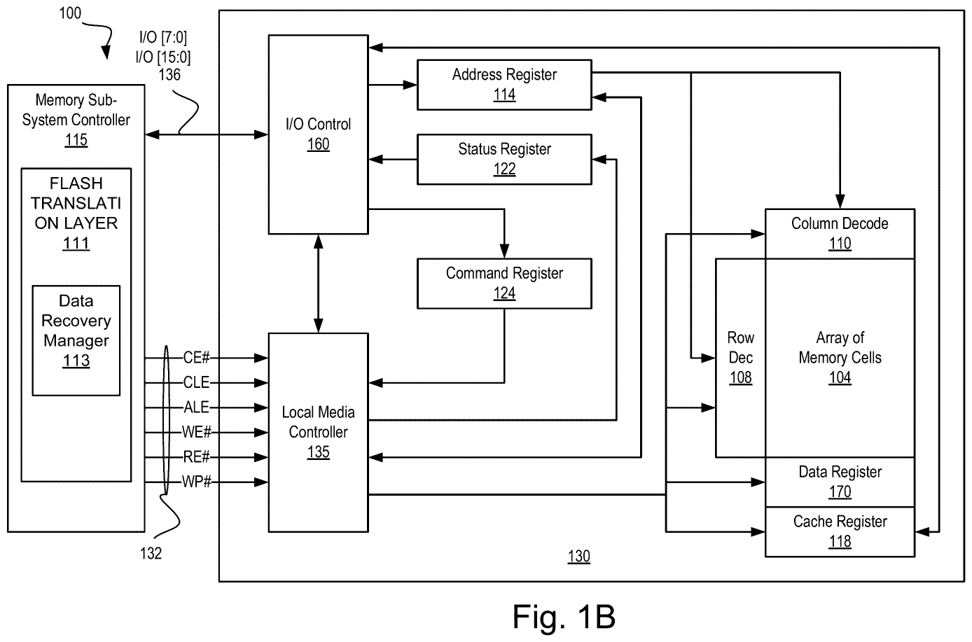

Aspects of the present disclosure are related to data recovery after a die failure in memory devices. A memory sub-system may be a storage device, a memory module, or a combination of a storage device and memory module. Examples of storage devices and memory modules are described below in conjunction with FIG. 1. In general, a host system may utilize a memory sub-system that includes one or more components, such as memory devices that store data. The host system may provide data to be stored at the memory sub-system and may request data to be retrieved from the memory sub-system.

A memory sub-system may utilize one or more memory devices, including any combination of the different types of non-volatile memory devices and/or volatile memory devices, to store the data provided by the host system. In some implementations, a memory sub-system may be represented by a solid-state drive (SSD), which may include one or more non-volatile memory devices. In some implementations, the non-volatile memory devices may be provided by negative-and (NAND) type flash memory devices. Other examples of non-volatile memory devices are described below in conjunction with FIG. 1. A non-volatile memory device is a package of one or more dies. Each die may include one or more planes. A plane is an independently accessible portion of a die, such that several planes of a die may be accessed concurrently. “Block” is the minimal erasable unit of memory, which includes multiple memory pages. “Page” is the minimal writable unit of memory, which includes multiple memory cells. A memory cell is an electronic circuit that stores information.

A memory device may include multiple memory cells arranged in a two-dimensional grid. The memory cells are formed onto a silicon wafer in an array of columns and rows. A memory cell includes a capacitor that holds an electric charge and a transistor that acts as a switch controlling access to the capacitor. Accordingly, the memory cell may be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells.

Depending on the cell type, each memory cell may store one or more bits of binary information and has various logic states that correlate to the number of bits being stored. The logic states may be represented by binary values, such as “0” and “1”, or combinations of such values. A memory cell may be programmed (written to) by applying a certain voltage to the memory cell, which results in an electric charge being held by the memory cell, thus allowing modulation of the voltage distributions produced by the memory cell. A set of memory cells referred to as a memory page may be programmed together in a single operation, e.g., by selecting consecutive bitlines.

Precisely controlling the amount of the electric charge stored by the memory cell allows establishing multiple logical levels, thus effectively allowing a single memory cell to store multiple bits of information. A read operation may be performed by comparing the measured threshold voltages (Vt) exhibited by the memory cell to one or more reference voltage levels in order to distinguish between two logical levels for single-level cell (SLCs) and between multiple logical levels for multi-level cells. Each logical level may be translated into a corresponding binary representation of the content of the memory cell. In an illustrative example, a Gray code may be employed for translating the cell charge levels (voltage levels) into their respective binary representations and vice versa. A Gray code refers to an encoding in which adjacent numbers have a single digit different by one.

Memory access operations (e.g., a read operation, a programming (write) operation, an erase operation, etc.) may be executed with respect to sets of the memory cells, e.g., in response to receiving memory access commands from the host. A memory access operation may specify the requested memory access operation (e.g., write, erase, read, etc.) and a logical address, which the memory sub-system would translate to a physical address identifying a set of memory cells (e.g., a block).

As noted herein above, a memory device may include one or more dies. Due to the physical degradation of memory cells, which is tracked by the bad block count, a die may need to be retired entirely if and when the bad block count reaches a threshold value. Besides, the memory sub-system should be capable of handling a sudden die failure, which manifests itself in unrecoverable error correction code (UECC) errors received by a large portion of read operations and/or program failure errors received by a large portion of write operations.

Irrespective of the cause of the die failure, the data stored on the failed die needs to be copied to other die(s) as soon as possible in order to prevent the loss of data. In some implementations, a die failure would trigger immediate folding of all block stripes.

“Block stripe” herein refers to a logical group of blocks including no more than one block from each plane that belongs to a set of dies (“LUN stripe”). Each block may only be a member of a single block stripe. In some implementations, one or more blocks of a block stripe may be dedicated to storing redundancy metadata (e.g., parity bits), which can be utilized for error detection and correction.

“Folding” herein refers to the internal migration of data from one physical location to another physical location, independent of any direct host interaction. Folding may be performed to pack valid data together (garbage collection), freeing more space for new writes, for error avoidance, for wear leveling, and/or to restore the parity protection in the event of an error. Some folding operations (e.g., garbage collection or static wear leveling) can be performed in the background with low priority. In some instances, priority folding may be performed, which would still yield to host workloads, and the “priority” would identify the order in which the data needs to be moved, rather than the speed at which the folding process would be performed.

Thus, if the die failure was caused by the slow physical degradation of memory cells, the data on that die would still be readable, thus allowing to perform a background folding process. However, in the case of a sudden die failure, immediate folding would need to be performed at a high priority, regardless of the host workload. Immediate folding may indicate both which data should be moved first and the speed at which the folding process should be performed. Furthermore, the data residing on the failed die would need to be recovered using a parity protection mechanism, such as Redundant Array of Independent NANDs (RAIN), which would involve performing read operations on non-failing die(s).

Furthermore, even though the sudden die failure results in uncorrectable read errors, the memory sub-system controller may still attempt to perform the Read Error Handling (REH) sequence, which will take significant time and may render the backend slow to handle other memory access operations. Besides, as the folding flow would not be able to throttle read errors on the failed die, the resulting error storm may have a significant impact on the entire memory sub-system, potentially leading to the deadlock state.

Aspects of the present disclosure alleviate the above-noted and other deficiencies by only folding the valid data on the failed die. In some implementations, the controller may iterate over the physical address space of the failed die and identify the blocks that contain valid data. Alternatively, the controller may iterate over the logical address space of the memory sub-system die and identify the blocks that reside on the failed die and contain valid data.

Furthermore, in some implementations, the REH sequence may be performed by the flash translation layer (FTL), thus eliminating the invocation of the backend to perform the REH sequence. Such a streamlined read flow would further improve the overall efficiency of handling the die failure.

Besides, in some implementations, the otherwise likely error storm may be avoided by limiting the rate of read requests that are triggered by the folding process. In an illustrative example, the controller can maintain a counter of error handling operations (including the read requests that are being triggered by the folding process and various other error handling operations). The controller can limit the rate of read requests that are triggered by the folding process if the counter exceeds a threshold value; the counter can be reset, e.g., at a chosen frequency.

Accordingly, aspects of the present disclosure improve the efficiency of memory access operations by implementing selective folding of the data residing on a failed die, streamlining the REH flows, and throttling the rate of read requests that are triggered by the folding process, as described in more detail herein below.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or a combination thereof.

FIG. 1 illustrates an example computing system 100 that includes a memory sub-system 110 in accordance with some implementations of the present disclosure. The memory sub-system 110 may include media, such as one or more volatile memory devices (e.g., memory device 140), one or more non-volatile memory devices (e.g., memory device 130), or a combination of such.

A memory sub-system 110 may be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 may include a host system 120 that is coupled to one or more memory sub-systems 110. In some implementations, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which may be an indirect communicative connection or direct communicative connection (e.g., without intervening components), whether wired or wireless, including connections such as electrical, optical, magnetic, etc.

The host system 120 may include a processor chipset and a software stack executed by the processor chipset. The processor chipset may include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 may be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface may be used to transmit data between the host system 120 and the memory sub-system 110. The host system 120 may further utilize an NVM Express (NVMe) interface to access components (e.g., memory devices 130) when the memory sub-system 110 is coupled with the host system 120 by the physical host interface (e.g., PCIe bus). The physical host interface may provide an interface for passing control, address, data, and other signals between the memory sub-system 110 and the host system 120. FIG. 1 illustrates a memory sub-system 110 as an example. In general, the host system 120 may access multiple memory sub-systems via a same communication connection, multiple separate communication connections, and/or a combination of communication connections.

The memory devices 130, 140 may include any combination of the different types of non-volatile memory devices and/or volatile memory devices. The volatile memory devices (e.g., memory device 140) may be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells may perform bit storage based on a change of bulk resistance, in conjunction with a stackable cross-gridded data access array. Additionally, in contrast to many flash-based memories, cross-point non-volatile memory may perform a write in-place operation, where a non-volatile memory cell may be programmed without the non-volatile memory cell being previously erased. NAND type flash memory includes, for example, two-dimensional NAND (2D NAND) and three-dimensional NAND (3D NAND).

Each of the memory devices 130 may include one or more arrays of memory cells. One type of memory cell, for example, single level cells (SLC) may store one bit per cell. Other types of memory cells, such as multi-level cells (MLCs), triple level cells (TLCs), quad-level cells (QLCs), and penta-level cells (PLCs) may store multiple bits per cell. In some implementations, each of the memory devices 130 may include one or more arrays of memory cells such as SLCs, MLCs, TLCs, QLCs, PLCs or any combination of such. In some implementations, a particular memory device may include an SLC portion, and an MLC portion, a TLC portion, a QLC portion, or a PLC portion of memory cells. The memory cells of the memory devices 130 may be grouped as pages that may refer to a logical unit of the memory device used to store data. With some types of memory (e.g., NAND), pages may be grouped to form blocks.

Although non-volatile memory components such as a 3D cross-point array of non-volatile memory cells and NAND type flash memory (e.g., 2D NAND, 3D NAND) are described, the memory device 130 may be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller (“controller”) 115 may communicate with the memory devices 130 to perform operations such as reading data, writing data, or erasing data at the memory devices 130 and other such operations. The memory sub-system controller 115 may include hardware such as one or more integrated circuits and/or discrete components, a buffer memory, or a combination thereof. The hardware may include a digital circuitry with dedicated (i.e., hard-coded) logic to perform the operations described herein. The memory sub-system controller 115 may be a microcontroller, special purpose logic circuitry (e.g., a field programmable gate array (FPGA), an application specific integrated circuit (ASIC), etc.), or other suitable processor.

The memory sub-system controller 115 may include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some implementations, the local memory 119 may include memory registers storing memory pointers, fetched data, etc. The local memory 119 may also include read-only memory (ROM) for storing micro-code. While the example memory sub-system 110 in FIG. 1 has been illustrated as including the memory sub-system controller 115, in another implementation of the present disclosure, a memory sub-system 110 does not include a memory sub-system controller 115, and may instead rely upon external control (e.g., provided by an external host, or by a processor or controller separate from the memory sub-system).

In operation, the memory sub-system controller 115 may receive commands or operations from the host system 120 and may convert the commands or operations into instructions or appropriate commands to achieve the desired access to the memory devices 130. The memory sub-system controller 115 may be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115, for example, may employ a Flash Translation Layer (FTL) 111 to translate logical addresses to corresponding physical memory addresses, which may be stored in one or more FTL mapping tables. In some instances, the FTL mapping table may be referred to as a logical-to-physical (L2P) mapping table storing L2P mapping information.

The memory sub-system controller 115 may further include host interface circuitry to communicate with the host system 120 via the physical host interface. The host interface circuitry may convert the commands received from the host system into command instructions to access the memory devices 130 as well as convert responses associated with the memory devices 130 into information for the host system 120.

The memory sub-system 110 may also include additional circuitry or components that are not illustrated. In some implementations, the memory sub-system 110 may include a cache or buffer (e.g., DRAM) and address circuitry (e.g., a row decoder and a column decoder) that may receive an address from the memory sub-system controller 115 and decode the address to access the memory devices 130.

In some implementations, the memory devices 130 include local media controllers 135 that operate in conjunction with memory sub-system controller 115 to execute operations on one or more memory cells of the memory devices 130. An external controller (e.g., memory sub-system controller 115) may externally manage the memory device 130 (e.g., perform media management operations on the memory device 130). In some implementations, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 may include a data recovery manager 113 that may be employed to perform the data recovery operations described herein. In some implementations, the controller 115 implements at least some functions of the data recovery manager 113. For example, the controller 115 may include a processor 117 (processing device) configured to execute instructions stored in local memory 119 for performing the operations described herein. In some implementations, the functions of the data recovery manager 113 are performed by the flash translation layer (FTL) 111 implemented by the controller 115 and/or local media controller(s) 135. In some implementations, at least some functions of the data recovery manager 113 are performed by the local media controllers 135. In some implementations, at least some functions of the data recovery manager 113 are performed by the host system 120.

In some implementations, the data recovery manager 113 may initiate folding the valid data on the failed die. In some implementations, the data recovery manager 113 may iterate over the physical address space of the failed die and identify the blocks that contain valid data. Alternatively, the data recovery manager 113 may iterate over the logical address space of the memory sub-system die and identify the blocks that reside on the failed die and contain valid data.

In some implementations, the otherwise likely error storm may be avoided by limiting the rate of read requests that are triggered by the folding process. In an illustrative example, the controller can maintain a counter of error handling operations (including the read requests that are being triggered by the folding process and various other error handling operations). The data recovery manager 113 can limit the rate of read requests that are triggered by the folding process if the counter exceeds a threshold value; the counter can be reset, e.g., at a chosen frequency.

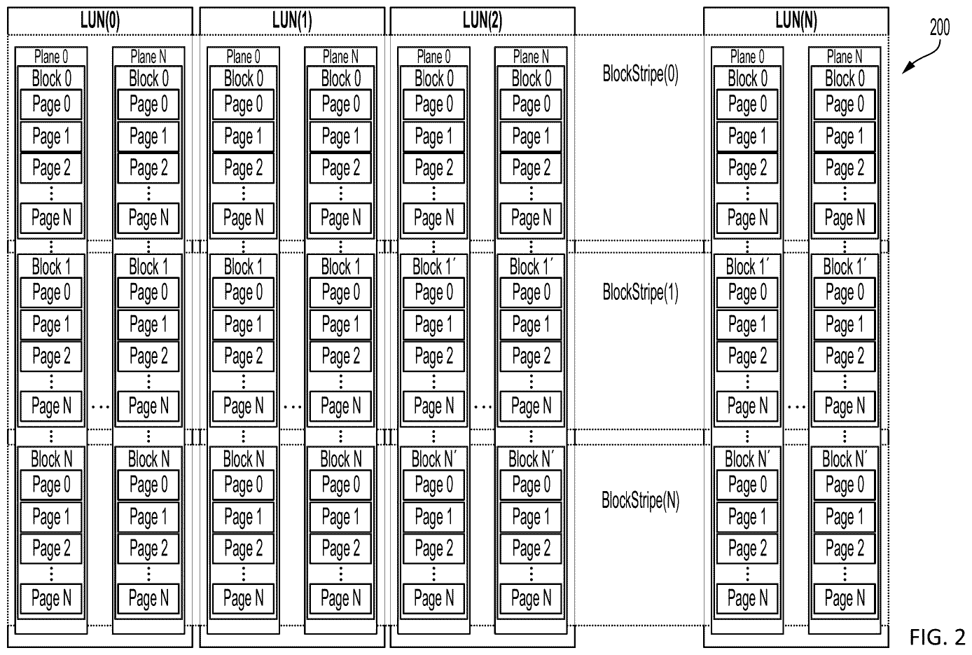

FIG. 2 schematically illustrates an example layout 200 of a memory device, in accordance with embodiments of the present disclosure. As schematically illustrated by FIG. 2, the memory device can include a plurality of dies identified by respective logical unit numbers (LUNs)(e.g., LUN(0) . . . (LUN(N)). Each die can include multiple planes (e.g., Plane0 . . . PlaneN), each plane hosting a respective set of blocks (e.g., Block0 . . . BlockN), and each block including a respective set of pages (Plane0 . . . PlaneN). Multiple blocks can be logically combined to form a superblock (not shown in FIG. 2 for clarity and conciseness), which includes at least one block from each plane of each die. Memory access operations, such as read, write, and/or erase operations, can be simultaneously performed on two or more pages, provided that each page is residing on a respective plane.

In some implementations, the memory subsystem controller can store the host data in a fault tolerant manner, by writing the host data sequentially blocks that are grouped into fault tolerant block stripes. As noted herein above, a block stripe can include no more than one block from each plane that belongs to a set of dies (“LUN stripe”).

Accordingly, each fault tolerant block stripe includes a certain number of data blocks (i.e., blocks that store host data) and a redundancy metadata block (e.g., BlockN in the illustrative example of FIG. 2) that stores the error correction metadata. In an illustrative example, the redundancy metadata can be represented by parity metadata, such that each bit of the metadata block of a fault tolerant stripe can be produced by performing bitwise exclusive disjunction (“XOR”) operation of respective bits of data blocks of the fault tolerant stripe. Such a redundancy scheme would provide fault tolerance in situations when no more than one block of a given fault tolerant stripe is faulty. The faulty block can be reconstructed by performing bitwise exclusive disjunction of all remaining data blocks and the metadata block.

Thus, in some implementations, a fault tolerant stripe can include a block from every plane of every logical unit of the memory device, such that all but one blocks of the fault tolerant stripe are utilized to store the host data, while the remaining block is utilized to store the redundancy metadata.

As noted herein above, due to the physical degradation of memory cells (e.g., caused by adverse environmental conditions), a sudden die failure may arise, which manifests itself in unrecoverable error correction code (UECC) errors received by a large portion of read operations and/or program failure errors received by a large portion of write operations.

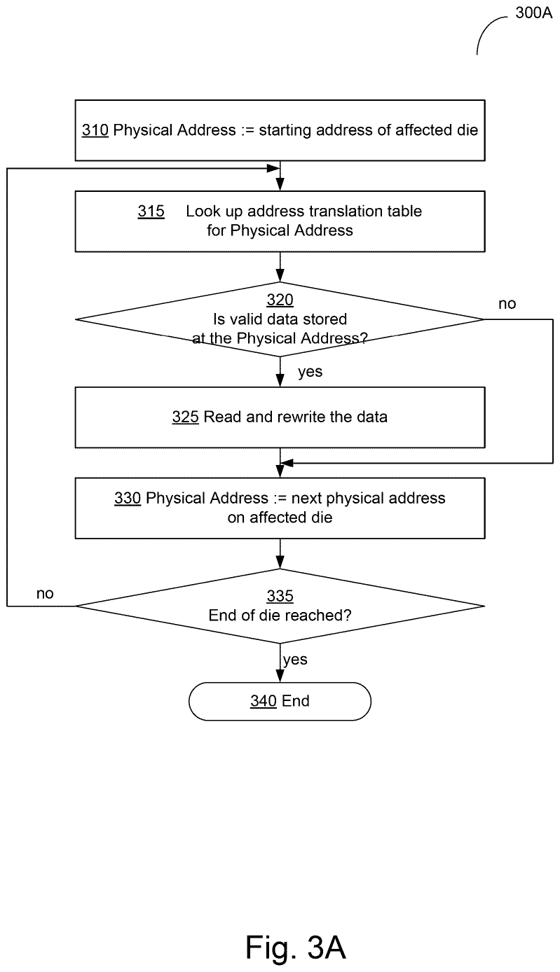

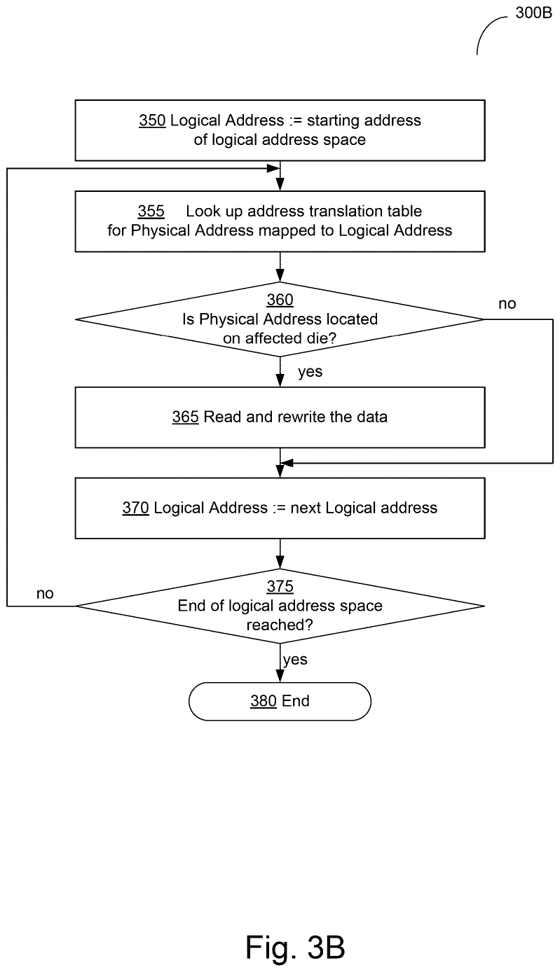

In the case of a sudden die failure, the memory sub-system controller can initiate immediate folding of valid data residing on the failed die. In some implementations, the controller may iterate over the physical address space of the failed die and identify the blocks that contain valid data, as described in more detail herein below with reference to FIG. 3A. Alternatively, the controller may iterate over the logical address space of the memory sub-system die and identify the blocks that reside on the failed die and contain valid data, as described in more detail herein below with reference to FIG. 3B.

FIG. 3A is a high-level flow diagram of an example method 300A of identifying valid data blocks by iterating over physical address space of a chosen (e.g., failed) die, by a memory sub-system controller operating in accordance with aspects of the present disclosure. The method 300A may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 300A may be performed by a single processing thread. Alternatively, method 300A may be performed by two or more processing threads, each thread executing one or more individual functions, routines, subroutines, or operations of the method. In an illustrative example, the processing threads implementing method 300A may be synchronized (e.g., using semaphores, critical sections, and/or other thread synchronization mechanisms). Alternatively, the processing threads implementing method 300A may be executed asynchronously with respect to each other. In some implementations, the method 300A is performed by the memory system controller (e.g., data recovery manager 113 of FIG. 1) and/or local media controller. Operations of the method 300A may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 310, the processing logic implementing the method initiates the physical address to the starting address of the chosen (e.g., failed) die. In an illustrative example, the physical address may be provided by an abstracted physical address that is utilized by the FTL. In some implementations, the abstracted physical address may specify the die identifier (LUN ID), the block identifier, the plane identifier, the page identifier, and the address of the transfer unit (TU). The components of the abstracted physical address are the logical values that are generated for ease of use (e.g., 0-based, consecutive, etc.), and thus might not be equal to their counterparts of a fully-qualified physical address (e.g., channel, chip enable, die, block, plane, page, TU offset). Accordingly, for performing a memory access operation (e.g., read, write, erase), the abstracted physical address can be translated to a fully-qualified physical address.

At operation 315, the processing logic looks up the physical address in the address translation data structure. In some implementations, the address translation data structure can be provided by an L2P table, which maps each logical address (e.g., logical block address (LBA)) to a corresponding physical address (e.g., an abstracted physical address). In an illustrative example, the L2P table is indexed by the LBA value, such that i-th entry of the L2P table stores the physical address (PA) corresponding to LBA=i. In some implementations, the PA field can store the result of applying the exclusive disjunction (XOR) operation to the PA and LBA (i.e., PA∧LBA), thus reserving the binary value of all “ones” (0xFFFFFFFF) for unmapped LBAs. In some implementations, each L2P table entry can further store one or more metadata values (such as program erase cycle (PEC) count, etc.). In an illustrative example, the L2P table entry has the size of 8 bytes, including 4 bytes allocated to the PA and 4 bytes allocated to the metadata; in various other implementations, L2P map entries and/or their individual fields of other sizes can be utilized. Thus, at operation 315, the processing logic identifies the L2P table entry corresponding to the current value of the physical address.

Responsive to determining, at operation 320, that the identified entry of the address translation data structure is referencing valid data, the processing continues at operation 325; otherwise, the method branches to operation 330.

At operation 325, the processing logic reads the data from the physical location identified by the current value of the physical address, recovers the data, and rewrites the data to a new physical location (e.g., to a non-failing die).

At operation 330, the processing logic increments the current value of the physical address.

Responsive to determining, at operation 335, that the end of the chosen die has been reached (e.g., the current value of the physical address points to a location outside the chosen die), the method terminates at operation 340; otherwise, the method loops back to operation 315.

FIG. 3B is a high-level flow diagram of an example method 300B of identifying valid data blocks by iterating over logical address space of the memory device, by a memory sub-system controller operating in accordance with aspects of the present disclosure. The method 300B may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 300B may be performed by a single processing thread. Alternatively, method 300B may be performed by two or more processing threads, each thread executing one or more individual functions, routines, subroutines, or operations of the method. In an illustrative example, the processing threads implementing method 300B may be synchronized (e.g., using semaphores, critical sections, and/or other thread synchronization mechanisms). Alternatively, the processing threads implementing method 300B may be executed asynchronously with respect to each other. In some implementations, the method 300B is performed by the memory system controller (e.g., data recovery manager 113 of FIG. 1) and/or local media controller. Operations of the method 300B may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 350, the processing logic implementing the method initiates the logical address to the starting address (e.g., 0) of the logical address space of the memory device.

At operation 355, the processing logic looks up the physical address in the address translation data structure. In some implementations, the address translation data structure can be provided by an L2P table, which maps each logical address (e.g., logical block address (LBA)) to a corresponding physical address (e.g., an abstracted physical address that is utilized by the FTL). In some implementations, the abstracted physical address may specify the die identifier (LUN ID), the block identifier, the plane identifier, the page identifier, and the address of the transfer unit (TU). The components of the abstracted physical address are the logical values that are generated for ease of use (e.g., 0-based, consecutive, etc.), and thus might not be equal to their counterparts of a fully-qualified physical address (e.g., channel, chip enable, die, block, plane, page, TU offset). Accordingly, for performing a memory access operation (e.g., read, write, erase), the abstracted physical address can be translated to a fully-qualified physical address.

In an illustrative example, the L2P table is indexed by the LBA value, such that i-th entry of the L2P table stores the physical address (PA) corresponding to LBA=i. In some implementations, the PA field can store the result of applying the exclusive disjunction (XOR) operation to the PA and LBA (i.e., PA∧LBA), thus reserving the binary value of all “ones” (0xFFFFFFFF) for unmapped LBAs. In some implementations, each L2P table entry can further store one or more metadata values (such as program erase cycle (PEC) count, etc.). In an illustrative example, the L2P table entry has the size of 8 bytes, including 4 bytes allocated to the PA and 4 bytes allocated to the metadata; in various other implementations, L2P map entries and/or their individual fields of other sizes can be utilized. Thus, at operation 315, the processing logic identifies the L2P table entry corresponding to the current value of the physical address.

Responsive to determining, at operation 360, that the identified entry of the address translation data structure is referencing a physical address that is located on the chosen die, the processing continues at operation 365; otherwise, the method branches to operation 370.

At operation 365, the processing logic reads the data from the physical location identified by the current value of the physical address, recovers the data, and rewrites the data to a new physical location (e.g., to a non-failing die).

At operation 370, the processing logic increments the current value of the logical address.

Responsive to determining, at operation 375, that the end of the logical address space has been reached (e.g., the current value of the logical address is outside of the logical address space), the method terminates at operation 380; otherwise, the method loops back to operation 355.

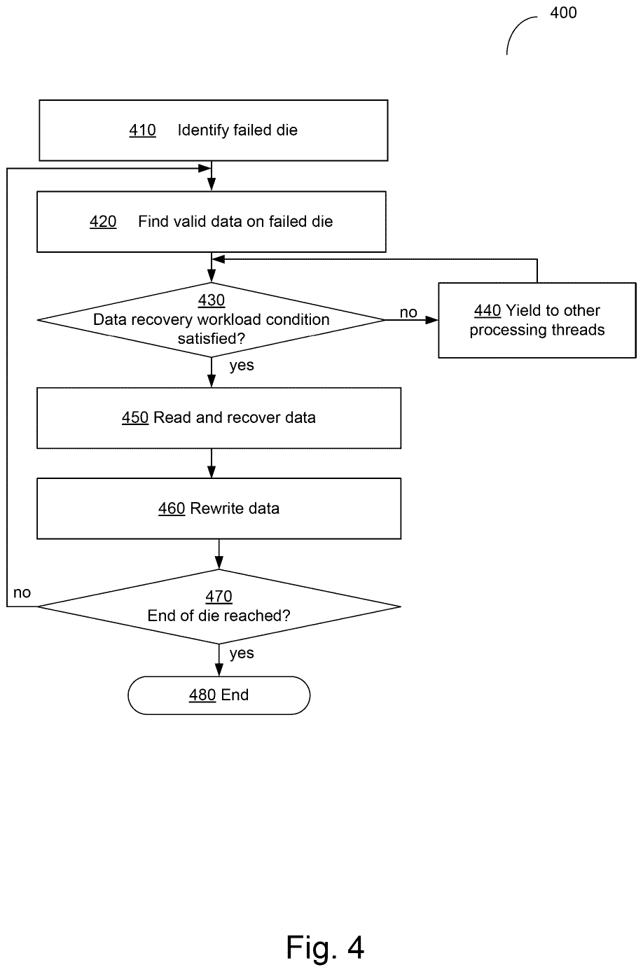

FIG. 4 is a high-level flow diagram of an example method 400 of performing data recovery after a die failure in a memory device, by a memory sub-system controller operating in accordance with aspects of the present disclosure. The method 400 may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In some implementations, the method 400 is performed by the memory system controller (e.g., data recovery manager 113 of FIG. 1) and/or local media controller. Operations of the method 400 may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 410, the processing logic implementing the method identifies, among a plurality of dies of a memory device, a failed die. In an illustrative example, a die is declared failed if unrecoverable error correction code (UECC) errors have been received by at least a predefined portion (e.g., 80%) of read operations and/or program failure errors have been received by at least a predefined portion (e.g., 80%) of write operations.

At operation 420, the processing logic implementing the method finds a valid data item on the failed die. In some implementations, the valid data items are identified by iterating over an address space associated with the failed die. In an illustrative example, the controller may iterate over the physical address space of the failed die and identify the blocks that contain valid data, as described in more detail herein above with reference to FIG. 3A. In another illustrative example, the controller may iterate over the logical address space of the memory sub-system die and identify the blocks that reside on the failed die and contain valid data, as described in more detail herein above with reference to FIG. 3B.

At operation 430, the processing logic evaluates the data recovery workload condition. In some implementations, the data recovery workload condition is satisfied when the system error count is below a predefined threshold value. The system error count may include the number of read/error handling operations performed in furtherance of data recovery workflows. In some implementations, the system error count may include the number of other errors/operations performed by the data recovery manager 113 and/or other system modules, except for host-initiated memory access operations. The system error count may be reset to zero at a predefined frequency, thus effectively throttling the background data recovery operations performed by the data recovery manager 113.

Responsive to determining, at operation 430, that the data recovery workload condition is satisfied, the processing continues at operation 450; otherwise, at operation 440, the processing logic yields to other processing threads at least for a predefined period of time.

At operation 450, the processing logic reads and recovers the valid data item (e.g., a block) stored on the chosen (e.g., failed) die. In some implementations, recovering the data item may involve decoding the data based on redundancy (e.g., parity) metadata, which may be stored on a non-failing die. In some implementations, recovering the data item may involve performing the REH workflow, which may involve, e.g., repeating the read strobes while adjusting the read voltages until a decodable codeword is retrieved.

At operation 460, the processing logic stores the recovered data to a new physical location (e.g., to a non-failing die).

Responsive to determining, at operation 470, that the end of the chosen die has been reached (e.g., the current value of the physical address points to a location outside the chosen die or the current value of the logical address is outside of the logical address space of the memory device), the method terminates at operation 480; otherwise, the method loops back to operation 420.

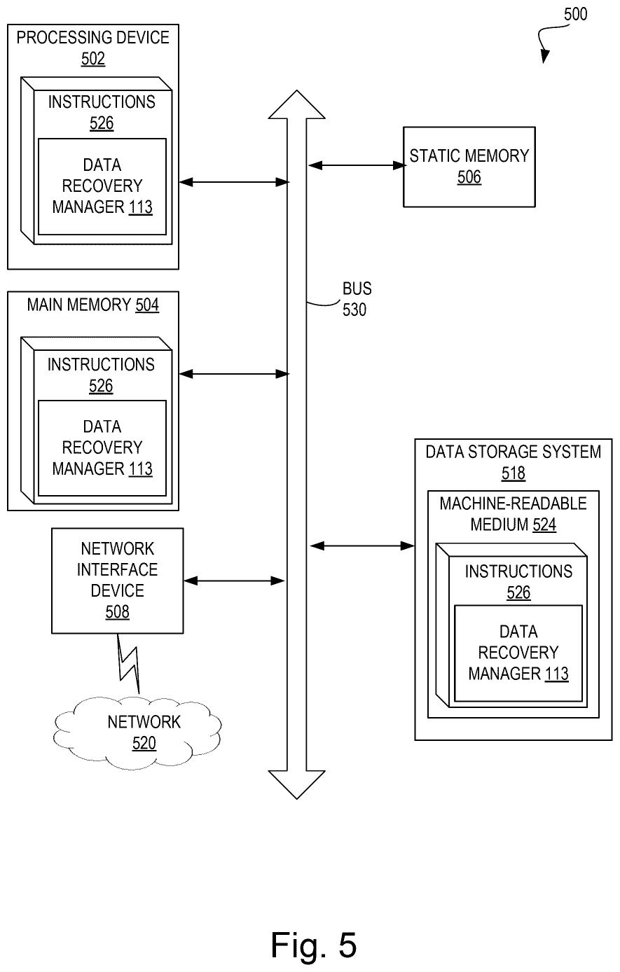

FIG. 5 illustrates an example machine of a computer system 500 within which a set of instructions, for causing the machine to perform any one or more of the methods discussed herein, may be executed. In some implementations, the computer system 500 may correspond to a host system (e.g., the host system 120 of FIG. 1) that includes, is coupled to, or utilizes a memory sub-system (e.g., the memory sub-system 110 of FIG. 1) or may be used to perform the operations of a controller (e.g., to execute an operating system to perform operations corresponding to the data recovery manager 113 of FIG. 1). In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methods discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 may further include a network interface device 508 to communicate over the network 520.

The data storage system 518 may include a machine-readable storage medium 524 (also known as a computer-readable medium) on which is stored one or more sets of instructions 526 or software embodying any one or more of the methods or functions described herein. The instructions 526 may also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 may correspond to the memory sub-system 110 of FIG. 1.

In one implementation, the instructions 526 include instructions to implement functionality corresponding to an error correction coding component (e.g., data recovery manager 113 of FIG. 1). While the machine-readable storage medium 524 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methods of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure may refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus may be specially constructed for the intended purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A system, comprising:
a memory device; and
a processing device, operatively coupled to the memory device, the processing device to:
identify among a plurality of dies of the memory device, a first die experiencing a failure;
identify, by iterating over an address space associated with the first die, a valid data item stored on the first die;
responsive to determining that a data recovery workload condition is satisfied, recover the valid data item; and
store the valid data item on a second die of the plurality of dies.

2. The system of claim 1, wherein the valid data item is a block storing valid data.

3. The system of claim 1, wherein the data recovery workload condition is represented by a system error count comprising a count of read requests issued for data recovery.

4. The system of claim 3, wherein the system error count further comprises a count of system errors.

5. The system of claim 1, wherein the address space is a logical address space of the memory device.

6. The system of claim 1, wherein the address space is a physical address space of the first die.

7. The system of claim 1, wherein recovering the valid data utilizes redundancy metadata stored on a third die of the plurality of dies.

8. A method, comprising:
identifying, by a processing device, among a plurality of dies of the memory device, a first die experiencing a failure;
identifying, by iterating over an address space associated with the first die, a valid data item stored on the first die;
responsive to determining that a data recovery workload condition is satisfied, recovering the valid data item; and
storing the valid data item on a second die of the plurality of dies.

9. The method of claim 8, wherein the valid data item is a block storing valid data.

10. The method of claim 8, wherein the data recovery workload condition is represented by a system error count comprising a count of read requests issued for data recovery.

11. The method of claim 10, wherein the system error count further comprises a count of system errors.

12. The method of claim 8, wherein the address space is a logical address space of the memory device.

13. The method of claim 8, wherein the address space is a physical address space of the first die.

14. The method of claim 8, wherein recovering the valid data utilizes redundancy metadata stored on a third die of the plurality of dies.

15. A non-transitory computer-readable storage medium comprising instructions that, when executed by a processing device, cause the processing device to:
identify, among a plurality of dies of the memory device, a first die experiencing a failure;
identify, by iterating over an address space associated with the first die, a valid data item stored on the first die;
responsive to determining that a data recovery workload condition is satisfied, recover the valid data item; and
store the valid data item on a second die of the plurality of dies.

16. The non-transitory computer-readable storage medium of claim 15, wherein the valid data item is a block storing valid data.

17. The non-transitory computer-readable storage medium of claim 15, wherein the data recovery workload condition is represented by a system error count comprising a count of read requests issued for data recovery.

18. The non-transitory computer-readable storage medium of claim 15, wherein the address space is a logical address space of the memory device.

19. The non-transitory computer-readable storage medium of claim 15, wherein the address space is a physical address space of the failed die.

20. The non-transitory computer-readable storage medium of claim 15, wherein recovering the valid data utilizes redundancy metadata stored on a second die of the plurality of dies.
